(19) United States
(12) Patent Application Publication
(10) Pub. No.: US 2024/0284553 A1
(43) Pub. Date: Aug. 22, 2024

(54) FAST RECOVERY AFTER EXITING COVERAGE HOLE

(71) Applicant: QUALCOMM Incorporated, San Diego, CA (US)

(72) Inventors: Jing DAI, Shanghai (CN); Xianwei ZHU, Beijing (CN); Manisha PRIYADARSHINI, San Diego, CA (US); Qin Xue FRANTTI, San Diego, CA (US); Xinning SHEN, San Diego, CA (US); Yiming XU, San Diego, CA (US); Xiao PENG, Beijing (CN); Hewu GU, Shanghai (CN); Yunjia NIU, Shanghai (CN); Shan QING, San Diego, CA (US); Sumit Kumar SINGH, San Marcos, CA (US); Xiaochen CHEN, Beijing (CN); Thomas CHRISTOL, Boulder, CO (US); Shanshan WANG, San Diego, CA (US); Arvind Vardarajan SANTHANAM, San Diego, CA (US); Yue HONG, San Diego, CA (US); Xiaoning LU, San Diego, CA (US); Xuqiang ZHANG, Beijing (CN); Jiming GUO, Beijing (CN); Tom CHIN, San Diego, CA (US); Jun DENG, Shanghai (CN); Peng HU, Beijing (CN)

(21) Appl. No.: 18/693,373

(22) PCT Filed: Dec. 2, 2021
(86) PCT No.: PCT/CN2021/134952

§ 371 Date: Mar. 19, 2024

(51) Int. Cl. H04W 76/30; H04W 24/08; H04W 76/15; H04W 76/19

(52) U.S. Cl. CPC H04W 76/30; H04W 24/08; H04W 76/15; H04W 76/19

(57) ABSTRACT

Various aspects of the present disclosure generally relate to wireless communication. In some aspects, a user equipment (UE) may disconnect from a first radio access technology (RAT) service, independent of signaling from the first RAT service, after sensing that the UE has entered a coverage hole. The UE may use a connection to a second RAT service while in the coverage hole in association with disconnecting from the first RAT service. The UE may disconnect from the second RAT service, independent of signaling from the second RAT service, after sensing that the UE has exited the coverage hole and before expiration of a radio link failure (RLF) timer for the second RAT service. The UE may reconnect to the first RAT service before expiration of an RLF timer for the first RAT service. Numerous other aspects are described.

### FIELD OF THE DISCLOSURE

Aspects of the present disclosure generally relate to wireless communication and to techniques and apparatuses for fast recovery of a service after exiting a coverage hole.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include disconnecting from a first radio access technology (RAT) service, independent of signaling from the first RAT service, after sensing that the UE has entered a coverage hole. The method may include using a connection to a second RAT service while in the coverage hole in association with disconnecting from the first RAT service. The method may include disconnecting from the second RAT service, independent of signaling from the second RAT service, after sensing that the UE has exited the coverage hole and before expiration of a radio link failure (RLF) timer for the second RAT service. The method may include reconnecting to the first RAT service before expiration of an RLF timer for the first RAT service.

Some aspects described herein relate to a UE for wireless communication. The user equipment may include a memory and one or more processors coupled to the memory. The one or more processors may be configured to disconnect from a first RAT service, independent of signaling from the first RAT service, after sensing that the UE has entered a coverage hole. The one or more processors may be configured to use a connection to a second RAT service while in the coverage hole in association with disconnecting from the first RAT service. The one or more processors may be configured to disconnect from the second RAT service, independent of signaling from the second RAT service, after sensing that the UE has exited the coverage hole and before expiration of an RLF timer for the second RAT service. The one or more processors may be configured to reconnect to the first RAT service before expiration of an RLF timer for the first RAT service.

Some aspects described herein relate to a non-transitory computer-readable medium that stores a set of instructions for wireless communication by a UE. The set of instructions, when executed by one or more processors of the UE, may cause the UE to disconnect from a first RAT service, independent of signaling from the first RAT service, after sensing that the UE has entered a coverage hole. The set of instructions, when executed by one or more processors of the UE, may cause the UE to use a connection to a second RAT service while in the coverage hole in association with disconnecting from the first RAT service. The set of instructions, when executed by one or more processors of the UE, may cause the UE to disconnect from the second RAT service, independent of signaling from the second RAT service, after sensing that the UE has exited the coverage hole and before expiration of an RLF timer for the second RAT service. The set of instructions, when executed by one or more processors of the UE, may cause the UE to reconnect to the first RAT service before expiration of an RLF timer for the first RAT service.

Some aspects described herein relate to an apparatus for wireless communication. The apparatus may include means for disconnecting from a first RAT service, independent of signaling from the first RAT service, after sensing that the apparatus has entered a coverage hole. The apparatus may include means for using a connection to a second RAT service while in the coverage hole in association with disconnecting from the first RAT service. The apparatus may include means for disconnecting from the second RAT service, independent of signaling from the second RAT service, after sensing that the apparatus has exited the coverage hole and before expiration of an RLF timer for the second RAT service. The apparatus may include means for reconnecting to the first RAT service before expiration of an RLF timer for the first RAT service.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of dual connectivity, in accordance with the present disclosure.

FIG. 4 is a diagram illustrating an example of a change in coverage due to a coverage hole, in accordance with the present disclosure.

FIG. 5 is a diagram illustrating an example associated with fast recovery of New Radio coverage, in accordance with the present disclosure.

FIG. 6 is a diagram illustrating an example process performed, for example, by a UE, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

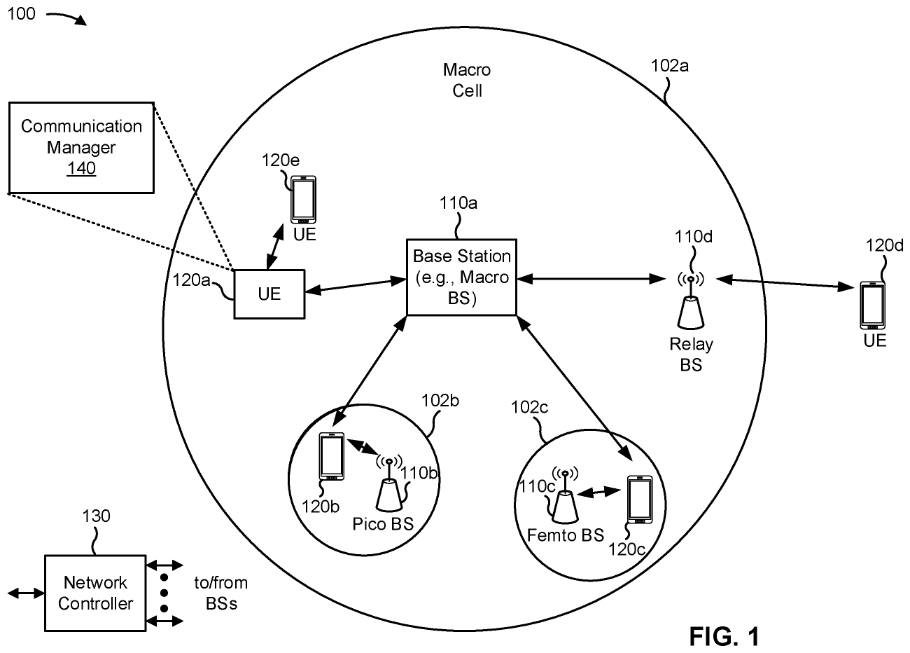

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to

In some aspects, the UE 120 may include a communication manager 140. As described in more detail elsewhere herein, the communication manager 140 may disconnect from a first RAT service, independent of signaling from the first RAT service, after sensing that the UE has entered a coverage hole. A coverage hole may be an area where the signal level, such as the signal-to-noise ratio (SNR) or signal-to-interference-plus-noise ratio (SINR) of both serving and allowed neighbor cells is below the level needed to maintain basis service, such as coverage of a physical downlink control channel (PDCCH). The coverage hole may be, for example, in an elevator. The communication manager 140 may use a connection to a second RAT service while in the coverage hole in association with disconnecting from the first RAT service. The communication manager 140 may disconnect from the second RAT service, independent of signaling from the second RAT service, after sensing that the UE has exited the coverage hole and before expiration of a radio link failure (RLF) timer for the second RAT service. The communication manager 140 may reconnect to the first RAT service before expiration of an RLF timer for the first RAT service. Additionally, or alternatively, the communication manager 140 may perform one or more other operations described herein.

As indicated above, FIG. 1 is provided as an example. Other examples may differ from what is described with regard to FIG. 1.

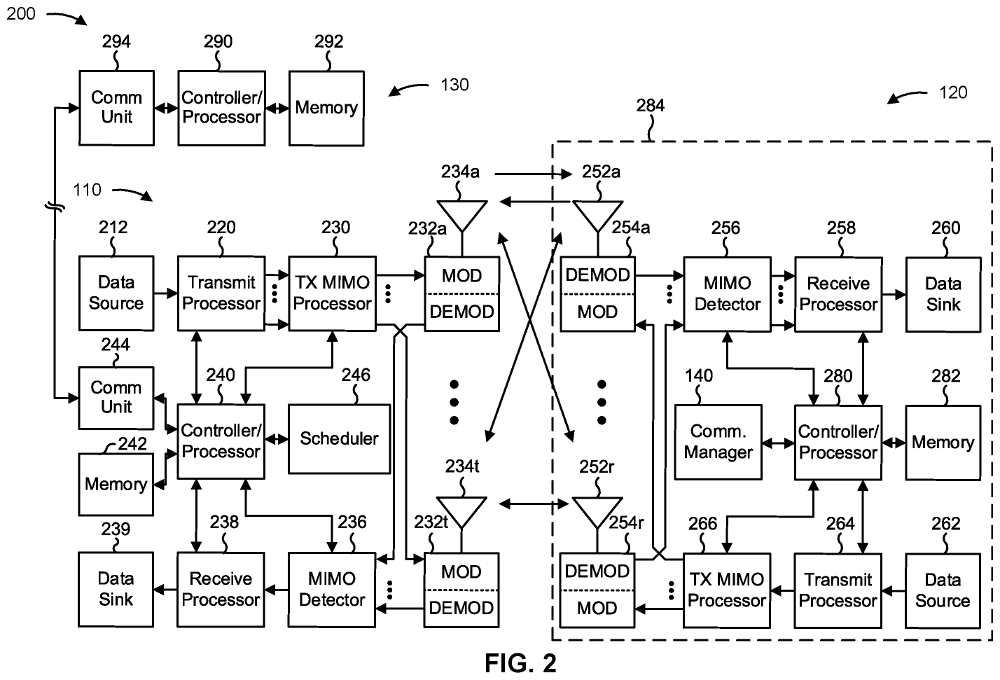

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

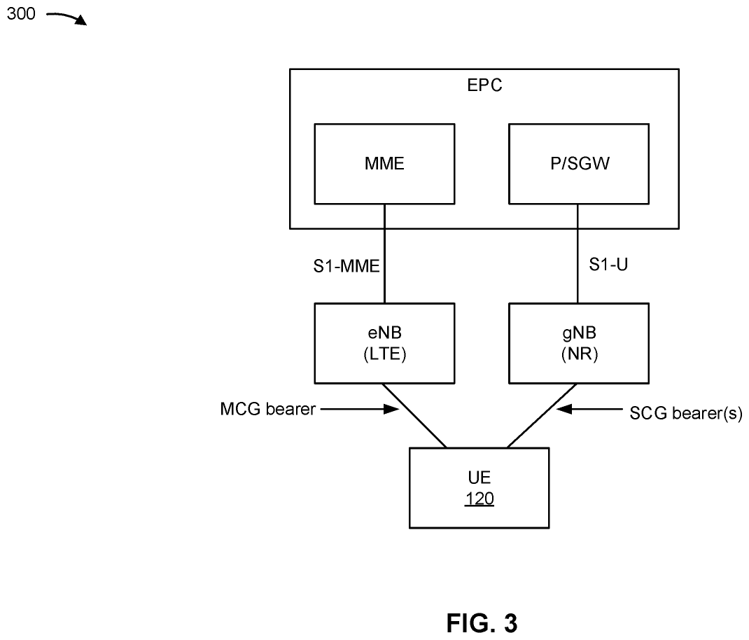

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-7).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-7).

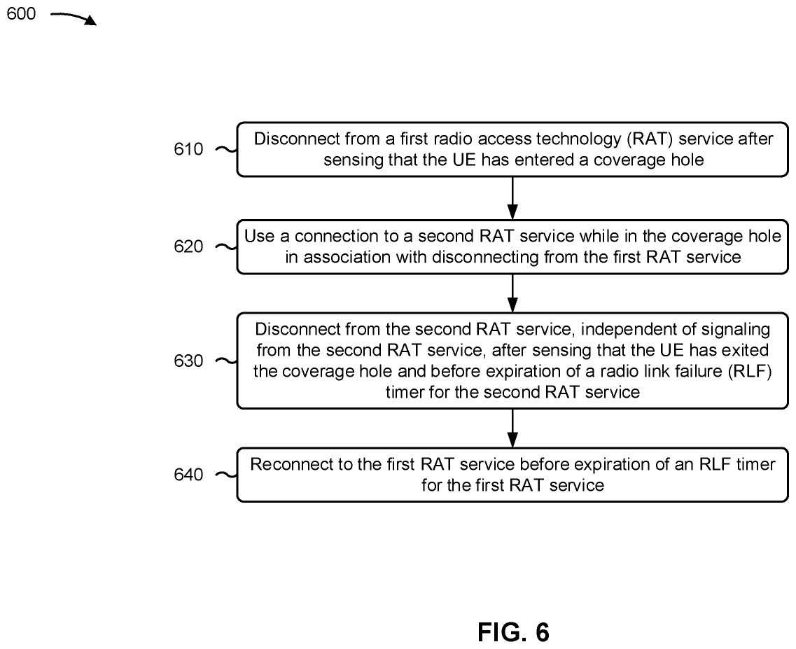

The controller/processor 240 of the base station 110, the controller/processor 280 of the UE 120, and/or any other component(s) of FIG. 2 may perform one or more techniques associated with fast recovery of NR service after exiting a coverage hole, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, and/or other processes as described herein. In some examples, executing instructions may include running the instructions, converting the instructions, compiling the instructions, and/or interpreting the instructions, among other examples.

In some aspects, the UE 120 includes means for disconnecting from a first RAT service, independent of signaling from the first RAT service, after sensing that the UE has entered a coverage hole (e.g., using antenna 252, modem 254, MIMO detector 256, receive processor 258, transmit processor 264, TX MIMO processor 266, controller/processor 280, memory 282, or the like); means for using a connection to a second RAT service while in the coverage hole in association with disconnecting from the first RAT service (e.g., using antenna 252, modem 254, MIMO detector 256, receive processor 258, transmit processor 264, TX MIMO processor 266, controller/processor 280, memory 282, or the like); means for disconnecting from the second RAT service, independent of signaling from the second RAT service, after sensing that the UE has exited the coverage hole and before expiration of an RLF timer for the second RAT service (e.g., using antenna 252, modem 254, MIMO detector 256, receive processor 258, transmit processor 264, TX MIMO processor 266, controller/processor 280, memory 282, or the like); and/or means for reconnecting to the first RAT service before expiration of an RLF timer for the first RAT service (e.g., using antenna 252, modem 254, MIMO detector 256, receive processor 258, transmit processor 264, TX MIMO processor 266, controller/processor 280, memory 282, or the like). The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of dual connectivity, in accordance with the present disclosure. A network may operate with a first RAT service, such as an NR service, in a mode for single connectivity, such as a standalone mode. A network may also operate in a mode for dual connectivity with the first RAT service (e.g., NR service) and a second RAT service (e.g., LTE service).

The example shown in FIG. 3 is for an Evolved Universal Mobile Telecommunications System Terrestrial Radio Access (E-UTRA)-NR dual connectivity (ENDC) mode. In the ENDC mode, a UE 120 communicates using an LTE RAT on a master cell group (MCG), and the UE 120 communicates using an NR RAT on a secondary cell group (SCG). However, aspects described herein may apply to an ENDC mode (e.g., where the MCG is associated with an LTE RAT and the SCG is associated with an NR RAT), an NR-E-UTRA dual connectivity (NEDC) mode (e.g., where the MCG is associated with an NR RAT and the SCG is associated with an LTE RAT), an NR dual connectivity (NRDC) mode (e.g., where the MCG is associated with an NR RAT and the SCG is also associated with the NR RAT), or another dual connectivity mode (e.g., where the MCG is associated with a first RAT and the SCG is associated with one of the first RAT or a second RAT). The ENDC mode is sometimes referred to as an NR or 5G non-standalone (NSA) mode. Thus, as used herein, “dual connectivity mode” may refer to an ENDC mode, an NEDC mode, an NRDC mode, and/or another type of dual connectivity mode.

As shown in FIG. 3, a UE 120 may communicate with both an eNB (e.g., a 4G base station 110) and a gNB (e.g., a 5G base station 110), and the eNB and the gNB may communicate (e.g., directly or indirectly) with a 4G/LTE core network, shown as an evolved packet core (EPC) that includes a mobility management entity (MME), a packet data network gateway (PGW), a serving gateway (SGW), and/or other devices. In FIG. 3, the PGW and the SGW are shown collectively as P/SGW. In some aspects, the eNB and the gNB may be co-located at the same base station 110. In some aspects, the eNB and the gNB may be included in different base stations 110 (e.g., may not be co-located).

As further shown in FIG. 3, in some aspects, a wireless network that permits operation in a 5G NSA mode may permit such operations using an MCG for a first RAT (e.g., an LTE RAT or a 4G RAT) and an SCG for a second RAT (e.g., an NR RAT or a 5G RAT). In this case, the UE 120 may communicate with the eNB via the MCG, and the UE 120 may communicate with the gNB via the SCG. In some aspects, the MCG may anchor a network connection between the UE 120 and the 4G/LTE core network (e.g., for mobility, coverage, and/or control plane information), and the SCG may be added as additional carriers to increase throughput (e.g., for data traffic and/or user plane information). In some aspects, the gNB and the eNB may not transfer user plane information between one another. In some aspects, a UE 120 operating in a dual connectivity mode may be concurrently connected with an LTE base station 110 (e.g., an eNB) and an NR base station 110 (e.g., a gNB) (e.g., in the case of ENDC or NEDC), or may be concurrently connected with one or more base stations 110 that use the same RAT (e.g., in the case of NRDC). In some aspects, the MCG may be associated with a first frequency band (e.g., a sub-6 GHz band and/or an FR1 band) and the SCG may be associated with a second frequency band (e.g., a millimeter wave band and/or an FR2 band). Operation by an NR network in FR1 may be a first RAT service, and operation by an NR network in FR2 may be a second RAT service.

The UE 120 may communicate via the MCG and the SCG using one or more radio bearers (e.g., data radio bearers (DRBs) and/or signaling radio bearers (SRBs)). For example, the UE 120 may transmit or receive data via the MCG and/or the SCG using one or more DRBs. Similarly, the UE 120 may transmit or receive control information (e.g., radio resource control (RRC) information and/or measurement reports) using one or more SRBs. In some aspects, a radio bearer may be dedicated to a specific cell group (e.g., a radio bearer may be an MCG bearer or an SCG bearer). In some aspects, a radio bearer may be a split radio bearer. A split radio bearer may be split in the uplink and/or in the downlink. For example, a DRB may be split on the downlink (e.g., the UE 120 may receive downlink information for the MCG or the SCG in the DRB) but not on the uplink (e.g., the uplink may be non-split with a primary path to the MCG or the SCG, such that the UE 120 transmits in the uplink only on the primary path). In some aspects, a DRB may be split on the uplink with a primary path to the MCG or the SCG. A DRB that is split in the uplink may transmit data using the primary path until a size of an uplink transmit buffer satisfies an uplink data split threshold. If the uplink transmit buffer satisfies the uplink data split threshold, the UE 120 may transmit data to the MCG or the SCG using the DRB.

As indicated above, FIG. 3 is provided as an example. Other examples may differ from what is described with respect to FIG. 3.

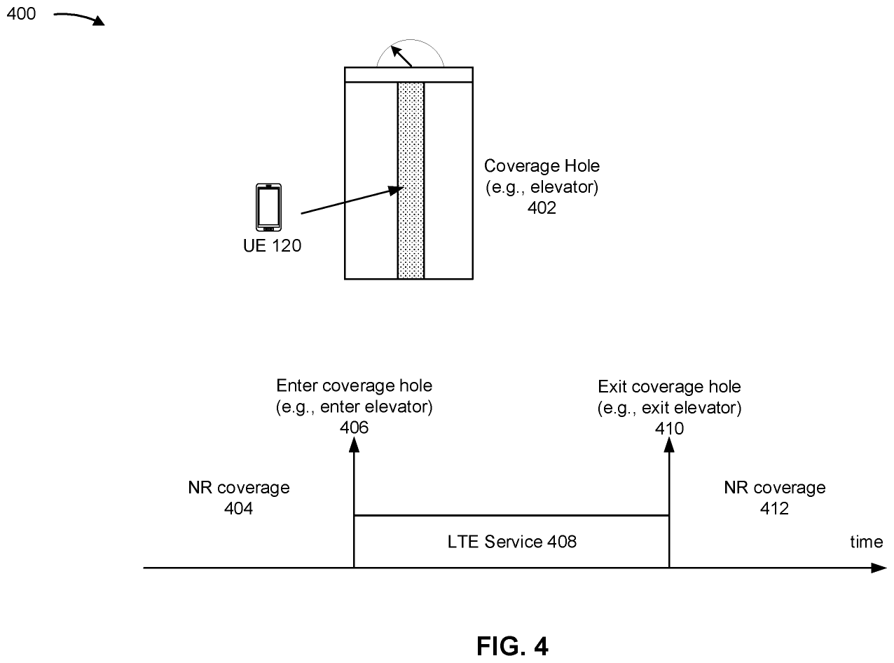

FIG. 4 is a diagram illustrating an example 400 of a change in coverage due to a coverage hole, in accordance with the present disclosure. Example 400 shows that a UE (e.g., a UE 120) may enter a coverage hole. A coverage hole may be an area where the signal level is below the level needed to maintain basic service. Entering a coverage hole may include, for example, entering an elevator, a tunnel, a below-ground floor (e.g., basement), an underground parking garage, or a subway. There may be other scenarios or dead zones that may be considered a coverage hole. Example 400 shows a coverage hole 402 that is the inside of an elevator.

The UE 120 may be connected to an NR service in NR coverage, as shown by reference number 404. As shown by reference number 406, the UE may enter the coverage hole 402. At this point the NR coverage is not available and the UE 120 is connected only to the LTE service, as shown by reference number 408. The UE 120 may not be aware that the UE 120 has entered the coverage hole 402 other than the UE 120 has lost the NR service. Detecting the loss of the NR service may also take some time. As shown by reference number 410, the UE 120 may exit the coverage hole 402. The UE 120 may reconnect to the NR service and have NR coverage again, as shown by reference number 412. However, this reconnection to the NR service may take some time because the UE 120 may not connect to the NR service until the UE 120 receives some signaling from the NR service. The longer the UE 120 takes to reenter NR coverage, the more data or control information that can be lost.

According to various aspects described herein, the UE 120 may sense (e.g., using sensors or RSRP) when the UE 120 has entered a coverage hole and disconnect from NR coverage. The UE 120 may use the LTE service while in the coverage hole. The UE 120 may then sense when the UE 120 has exited the coverage hole and reconnect to the NR coverage. By sensing the entrance and exit of the coverage hole, the UE 120 does not rely on signaling from the network and thus the UE 120 may reenter NR coverage faster. As a result, the UE 120 may lose less data and control information, and the user experience may improve by utilizing NR coverage sooner.

As indicated above, FIG. 4 is provided as an example. Other examples may differ from what is described with regard to FIG. 4.

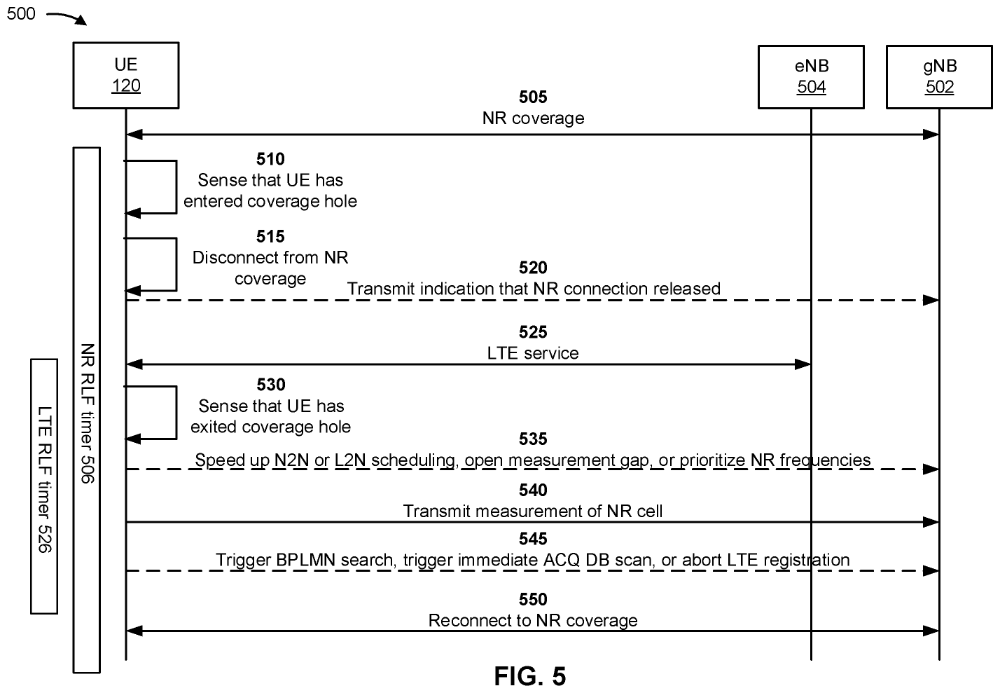

FIG. 5 is a diagram illustrating an example 500 associated with fast recovery of NR coverage, in accordance with the present disclosure. As shown in FIG. 5, the UE 120 may communicate with a base station for NR, or a gNB 502 (e.g., base station 110), and a base station for LTE, or an eNB (e.g., base station 110).

Example 500 shows fast recovery of NR coverage. As shown by reference number 505, the UE 120 may be in NR coverage and served by gNB 502. While NR coverage is described as an example of a first RAT service, the aspects described herein may apply to other enhanced RATs or RAT services. While the second RAT service in example 500 is the LTE service, in other scenarios, the first RAT service is NR in FR1, and the second RAT service is NR in FR2. That is, example 500 may apply to single connectivity NR coverage or dual connectivity NR coverage, as described above in connection with FIG. 3.

As part of the NR coverage, the UE 120 may be aware of an RLF timer for the NR coverage that runs at the gNB 502. The UE 120 may keep the same RLF timer, shown as NR RLF timer 506. The NR RLF timer may be, for example, a T310/T311 timer.

The UE 120 may enter a coverage hole. As shown by reference number 510, the UE 120 may sense that the UE 120 has entered the coverage hole. The sensing may include obtaining one or more sensor values from one or more sensors. The values may include a signal strength value, an accelerometer value, a proximity sensor value, a barometric pressure value, a light sensor value, a positioning value, a microphone input value, or any combination thereof. For example, a proximity sensor may sense the walls of the elevator. A positioning sensor may sense a height change or sense that the UE 120 is in a known position of an elevator. The UE 120 may detect the sounds of an elevator from microphone input.

Sensing that the UE 120 has entered a coverage hole may include sensing that the UE 120 has entered the coverage hole based at least in part on a determination that one or more sensor values have satisfied a coverage hole threshold. For example, the UE 120 may determine that the acceleration of an elevator has satisfied an acceleration threshold (e.g., minimum acceleration). The UE 120 may determine that a drop in the RSRP has satisfied a signal strength change threshold (e.g., minimum decrease in RSRP for a specified time period). In some aspects, the UE 120 may use machine learning and/or stored configuration information to determine from a combination of sensor values whether the UE 120 has entered a coverage hole.

As shown by reference number 515, the UE 120 may disconnect from the NR coverage if the UE 120 senses that the UE 120 has entered a coverage hole. Disconnecting from NR coverage may include releasing or ignoring an NR connection. Disconnecting from NR coverage may also include transmitting a message that the UE 120 is to ignore or release the NR connection, as shown by reference number 520. The UE 120 may disconnect from the NR coverage without, or independent of, any signaling from the network that would indicate that the connection is to be released. Alternatively, the UE 120 may disconnect from NR coverage based at least in part on signaling from the network.

As shown by reference number 525, the UE 120 is now using a connection to the LTE service while in the coverage hole. The UE 120 may be served by eNB 504. Use of the LTE service may include starting an LTE RLF timer 526. The LTE RLF timer 526 may be, for example, a T310/T311 timer. In some aspects, the UE 120 may have been in a dual connectivity mode with both NR and LTE and is now using only LTE. The UE 120 may drop the NR coverage but maintain the LTE coverage. In some aspects, the UE 120 may have been in a single connectivity mode and thus has switched from NR coverage to LTE coverage, which includes establishing a connection with the LTE service.

As shown by reference number 530, the UE 120 may sense that the UE 120 has exited the coverage hole. This may include determining that the one or more sensor values no longer satisfy the coverage hole threshold. For example, the UE 120 may determine that the (vertical) acceleration has ceased, that the position of the UE 120 is no longer changing in height, that the UE 120 is no longer in a known position of the elevator, that the barometric pressure has changed, and/or that there are sounds associated with an elevator stopping and opening its doors. In some aspects, the UE 120 may use machine learning and/or stored configuration information to determine from a combination of sensor values whether the UE 120 has exited a coverage hole.

The UE 120, having sensed that the UE 120 has exited the coverage hole (or is about to exit the coverage hole), may perform one or more actions for fast recovery of the NR coverage. These actions may be without, or independent of, any signaling from the network indicating that the UE 120 is to reestablish NR coverage. As a result of sensing the exit of the coverage hole rather than waiting for network signaling, the UE 120 may recover NR coverage faster and have improved service.

In some aspects, to enter NR coverage faster, as shown by reference number 535, the UE 120 may speed up LTE to NR (L2NR) scheduling or NR to NR (N2N or NR2NR) scheduling. This may include prioritizing when NR measurements are taken and transmitted. For example, in a dual connectivity mode, the NR network may establish or reestablish an NR connection upon receiving measurement for an NR cell or NR neighbor cell. The UE 120 may autonomously open up a measurement gap such that, instead of receiving downlink communications, the UE 120 is performing NR measurements. The autonomously opened measurement gap may be sooner than a scheduled measurement gap. The UE 120 may also prioritize the use of NR frequencies over other frequencies. The UE 120 may prioritize last-camped NR frequencies based on acquisition (ACQ) database information.

As shown by reference number 540, the UE 120 may transmit a measurement for an NR cell to reestablish a connection to the NR network and recover NR coverage. The measurement may be transmitted faster than if the UE 120 waited for network signaling and thus the NR coverage is recovered faster. The UE 120 may trigger measurement-based reselection, redirection, or handover.

In some aspects, as shown by reference number 545, the UE 120 may trigger a background public land mobile network (BPLMN) search if no neighbor frequency is configured. The BPLMN may normally take some time. The UE 120 may trigger a direct ACQ database scan. The UE 120 may abort LTE registration.

As shown by reference number 550, the UE 120 may reconnect to NR coverage. If the UE 120 is in single connectivity mode, the UE 120 may disconnect from the LTE service. The disconnection from the LTE service may occur before expiration of the LTE RLF timer 526. The UE 120 may reconnect to NR before expiration of the NR RLF timer 506. In this way, the UE 120 may avoid post-RLF procedures, which take additional time and consume additional signaling resources. The optimizations discussed in example 500 may be limited to a certain time window in order for the UE 120 to control the power consumption.

The UE 120 may perform different operations upon exit of the coverage hole depending on an NR standalone mode scenario of the UE 120. For example, in an NR standalone mode, if the UE 120 transitions from NR (idle) to out of service (OOS)/reselection and to the LTE service after entering the coverage hole, the UE 120 may, after exiting the coverage hole, speed up L2NR scheduling if there are available NR neighbors. If there are no available NR neighbors, the UE 120 may trigger an immediate BPLMN search and select to NR if any available cell is found. If the UE transitions from NR (idle) to OOS/NR (idle), to the LTE service, and to OOS after entering the coverage hole, the UE 120 may, after exiting the coverage hole, trigger an immediate ACQ database scan starting from NR. The UE 120 may abort the LTE registration to mitigate delay caused by the UE 120 performing LTE registration. If the UE 120 transitions from NR (idle) time division duplexing (TDD) to OOS/reselection and to NR (idle) frequency division duplexing (FDD) after entering the coverage hole, the UE 120 may, after exiting the coverage hole, speed up N2N scheduling if there are available NR neighbors. If there are no available NR neighbors, the UE 120 may use the last camped NR frequency. If the UE 120 transitions from NR (idle) to OOS and to 2G/3G, the UE 120, after exiting the coverage hole, may transition from 2G/3G to LTE using a legacy elevator mode mitigation (e.g., adjustment of resource use or procedures in association with having been in an elevator). The UE 120 may transition from LTE to NR using L2NR elevator mode mitigation.

The UE 120 may perform other operations upon exit of the coverage hole depending on an NR standalone mode scenario of the UE 120. For example, in an NR standalone mode, if the UE 120 transitions from NR (connect) to RLF and to the LTE service after entering the coverage hole, the UE 120 may, after exiting the coverage hole, prioritize NR frequencies based at least in part on a history of recent camping information (in a database) and/or speed up L2NR scheduling if there available NR neighbors. If there are no available NR neighbors, the UE 120 may autonomously open a measurement gap to scan for and measure NR frequencies based at least in part on the last camp information and/or trigger a local fast redirection to NR (if an available NR cell is found). An available cell is to satisfy an internal evaluation threshold (e.g., minimum RSRP), which may be obtained from the history of recent camping information. If the UE 120 transitions from NR (connect) to RLF and to NR low band (LB) after entering the coverage hole, the UE 120 may speed up N2N scheduling after exiting the coverage hole. If the UE 120 transitions from NR (connect) to RLF, to OOS, and to 2G/3G, the UE 120, after exiting the coverage hole, may transition from 2G/3G to LTE and to NR using elevator mode mitigations. If the UE 120 transitions from NR (idle) to OOS/reselection and to LTE registration after entering the coverage hole, the UE 120, after exiting the coverage hole, may abort the LTE registration and apply an elevator mode operation (e.g., reduction in processing resource and/or signaling resources). If the UE 120 transitions from NR RLF recovery to OOS and to LTE after entering the coverage hole, the UE 120, after exiting the coverage hole, may apply an elevator mode operation if the NR RLF is not caused by expiration of the NR RLF timer (e.g., a T310/T311 timer).

In some aspects, whether in NR standalone mode or in NRDC mode, if the UE 120 transitions from NR high band (HB) to RLF and to NR LB after entering the coverage hole, the UE 120, after exiting the coverage hole, may speed up an FR1 to FR2 search. In some aspects, the UE 120 may return to the NR HB cell. The UE 120 may select to a non-neighbor HB cell.

The UE 120 may perform different operations upon exit of the coverage hole depending on an NR dual connectivity mode scenario of the UE 120. For example, in ENDC mode, if the UE 120 transitions from ENDC (connect) to NR SCG RLF and to LTE after entering the coverage hole, the UE 120, after exiting the coverage hole, may speed up L2NR scheduling. In NRDC mode, if the UE 120 transitions from FR1+FR2 DC (dual connectivity) to FR2 SCG RLF and to NR FR1 standalone after entering the coverage hole, the UE 120 may, after exiting the coverage hole, speed up N2N scheduling.

In some aspects, the UE 120 may transition from dual connectivity (first RAT service and second RAT service) to single connectivity (only first RAT service or only second RAT service) after sensing that the UE 120 has entered the coverage whole. This may be ENDC to LTE, ENDC to NR, NRDC to LTE, or NRDC to NR. After sensing that the UE 120 has exited (or is about to exit) the coverage whole, the UE 120 may return to ENDC or NRDC (both first RAT service and second RAT service).

By using such procedures after sensing an exit from a coverage hole, the UE 120 may obtain or return to NR coverage faster, even if NR neighbors are not well configured. This may benefit single connectivity and dual connectivity scenarios. The UE 120, as part of fast recovery of NR coverage, may be aware of RLF timers and transition out of LTE and into NR before expiration of such timers.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with fast recovery of NR coverage after exiting a coverage hole.

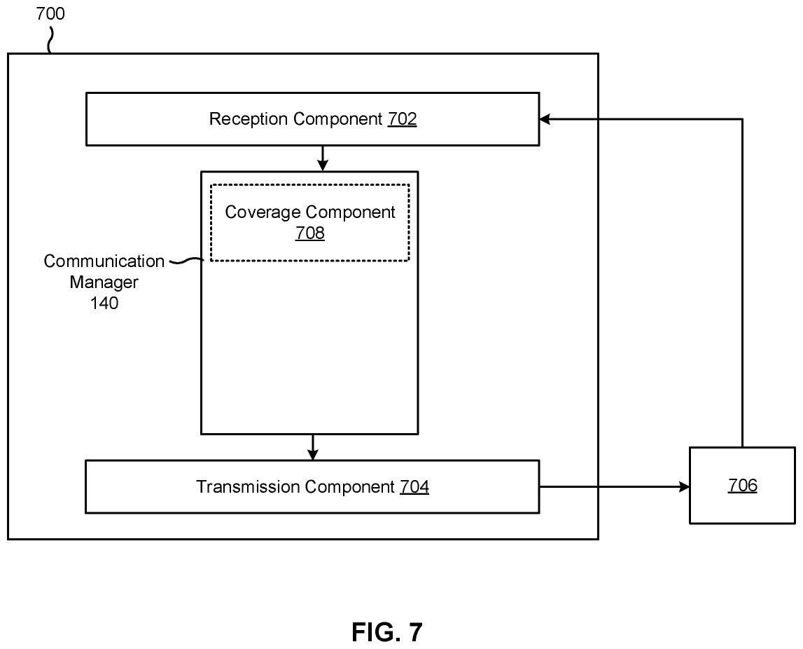

As shown in FIG. 6, in some aspects, process 600 may include disconnecting from a first RAT service (e.g., NR service) after sensing that the UE has entered a coverage hole (block 610). For example, the UE (e.g., using communication manager 140 and/or coverage component 708 depicted in FIG. 7) may disconnect from a first RAT service after sensing that the UE has entered a coverage hole, as described above, for example, with reference to FIGS. 3, 4, and/or 5. In some aspects, the disconnecting may be independent of signaling from the first RAT service (and the second RAT service).

As further shown in FIG. 6, in some aspects, process 600 may include using a connection to a second RAT service while in the coverage hole in association with disconnecting from the first RAT service (block 620). For example, the UE (e.g., using communication manager 140 and/or coverage component 708 depicted in FIG. 7) may use a connection to a second RAT service while in the coverage hole in association with disconnecting from the first RAT service, as described above, for example, with reference to FIGS. 3, 4, and/or 5.

As further shown in FIG. 6, in some aspects, process 600 may include disconnecting from the second RAT service, independent of signaling from the second RAT service, after sensing that the UE has exited the coverage hole and before expiration of an RLF timer for the second RAT service (block 630). For example, the UE (e.g., using communication manager 140 and/or coverage component 708 depicted in FIG. 7) may disconnect from the second RAT service, independent of signaling from the second RAT service, after sensing that the UE has exited the coverage hole and before expiration of an RLF timer for the second RAT service, as described above, for example, with reference to FIGS. 3, 4, and/or 5.

As further shown in FIG. 6, in some aspects, process 600 may include reconnecting to the first RAT service before expiration of an RLF timer for the first RAT service (block 640). For example, the UE (e.g., using communication manager 140 and/or coverage component 708 depicted in FIG. 7) may reconnect to the first RAT service before expiration of an RLF timer for the first RAT service, as described above, for example, with reference to FIGS. 3, 4, and/or 5.

Process 600 may include additional aspects, such as any single aspect or any combination of aspects described below and/or in connection with one or more other processes described elsewhere herein.

In a first aspect, sensing that the UE has entered the coverage hole includes sensing that the UE has entered the coverage hole based at least in part on a determination that one or more sensor values have satisfied a coverage hole threshold, and sensing that the UE has exited the coverage hole includes sensing that the UE has exited the coverage hole based at least in part on a determination that one or more sensor values no longer satisfy the coverage hole threshold.

In a second aspect, alone or in combination with the first aspect, the one or more sensor values include one or more of a signal strength value, an accelerometer value, a proximity sensor value, a barometric pressure value, a light sensor value, a positioning value, a microphone input value, or any combination thereof.

In a third aspect, alone or in combination with one or more of the first and second aspects, sensing that the UE has entered the coverage hole includes sensing that the UE has entered an elevator, a tunnel, a below-ground floor, underground parking, or a subway, and sensing that the UE has exited the coverage hole includes sensing that the UE has exited the elevator, the tunnel, the below-ground floor, the underground parking, or the subway.

In a fourth aspect, alone or in combination with one or more of the first through third aspects, the first RAT service is an NR service, and the second RAT service is an LTE service.

In a fifth aspect, alone or in combination with one or more of the first through fourth aspects, the first RAT service is a standalone NR service.

In a sixth aspect, alone or in combination with one or more of the first through fifth aspects, the first RAT service is a dual connectivity NR service (e.g., ENDC, NRDC).

In a seventh aspect, alone or in combination with one or more of the first through sixth aspects, reconnecting to the first RAT service includes, if an available NR neighbor is found, prioritizing NR frequencies, prioritizing scheduling of NR measurements, or any combination thereof.

In an eighth aspect, alone or in combination with one or more of the first through seventh aspects, reconnecting to the first RAT service includes, if an available NR neighbor is found, opening an autonomous gap for NR measurements.

In a ninth aspect, alone or in combination with one or more of the first through eighth aspects, reconnecting to the first RAT service includes, if an available NR neighbor is found, triggering local fast redirection to the first RAT service.

In a tenth aspect, alone or in combination with one or more of the first through ninth aspects, reconnecting to the first RAT service includes triggering an acquisition database scan starting from NR.

In an eleventh aspect, alone or in combination with one or more of the first through tenth aspects, reconnecting to the first RAT service includes aborting LTE registration.

In a twelfth aspect, alone or in combination with one or more of the first through eleventh aspects, reconnecting to the first RAT service includes, if no available NR neighbor is found triggering a BPLMN search, and connecting to the NR service if an NR cell is found.

In a thirteenth aspect, alone or in combination with one or more of the first through twelfth aspects, the first RAT service is an NR service in FR1, and the second RAT service is an NR service in FR2.

In a fourteenth aspect, alone or in combination with one or more of the first through thirteenth aspects, the first RAT service is an NR service in FR2, and the second RAT service is an NR service in FR1.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE (e.g., a UE 120), or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include a coverage component 708, among other examples.

In some aspects, the apparatus 700 may be configured to perform one or more operations described herein in connection with FIGS. 1-5. Additionally, or alternatively, the apparatus 700 may be configured to perform one or more processes described herein, such as process 600 of FIG. 6. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The coverage component 708 may disconnect from a first RAT service, independent of signaling from the first RAT service, after sensing that the UE has entered a coverage hole. The coverage component 708 may use a connection to a second RAT service while in the coverage hole in association with disconnecting from the first RAT service. The coverage component 708 may disconnect from the second RAT service, independent of signaling from the second RAT service, after sensing that the UE has exited the coverage hole and before expiration of an RLF timer for the second RAT service. The coverage component 708 may reconnect to the first RAT service before expiration of an RLF timer for the first RAT service.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed by a user equipment (UE), comprising: disconnecting from a first radio access technology (RAT) service, independent of signaling from the first RAT service, after sensing that the UE has entered a coverage hole; using a connection to a second RAT service while in the coverage hole in association with disconnecting from the first RAT service; disconnecting from the second RAT service, independent of signaling from the second RAT service, after sensing that the UE has exited the coverage hole and before expiration of a radio link failure (RLF) timer for the second RAT service; and reconnecting to the first RAT service before expiration of an RLF timer for the first RAT service.
Aspect 2: The method of Aspect 1, wherein sensing that the UE has entered the coverage hole includes sensing that the UE has entered the coverage hole based at least in part on a determination that one or more sensor values have satisfied a coverage hole threshold, and wherein sensing that the UE has exited the coverage hole includes sensing that the UE has exited the coverage hole based at least in part on a determination that one or more sensor values no longer satisfy the coverage hole threshold.
Aspect 3: The method of Aspect 2, wherein the one or more sensor values include one or more of a signal strength value, an accelerometer value, a proximity sensor value, a barometric pressure value, a light sensor value, a positioning value, a microphone input value, or any combination thereof.
Aspect 4: The method of any of Aspects 1-3, wherein sensing that the UE has entered the coverage hole includes sensing that the UE has entered an elevator, a tunnel, a below-ground floor, underground parking, or a subway, and wherein sensing that the UE has exited the coverage hole includes sensing that the UE has exited the elevator, the tunnel, the below-ground floor, the underground parking, or the subway.
Aspect 5: The method of any of Aspects 1-4, wherein the first RAT service is a New Radio (NR) service, and the second RAT service is a Long Term Evolution (LTE) service.
Aspect 6: The method of Aspect 5, wherein the first RAT service is a standalone NR service.
Aspect 7: The method of Aspect 5, wherein the first RAT service is a dual connectivity NR service.
Aspect 8: The method of Aspect 5, wherein reconnecting to the first RAT service includes, if an available NR neighbor is found, prioritizing NR frequencies, prioritizing scheduling of NR measurements, or any combination thereof.
Aspect 9: The method of Aspect 5, wherein reconnecting to the first RAT service includes, if an available NR neighbor is found, opening an autonomous gap for NR measurements.
Aspect 10: The method of Aspect 5, wherein reconnecting to the first RAT service includes, if an available NR neighbor is found, triggering local fast redirection to the first RAT service.
Aspect 11: The method of Aspect 5, wherein reconnecting to the first RAT service includes triggering an acquisition database scan starting from NR.
Aspect 12: The method of Aspect 5, wherein reconnecting to the first RAT service includes aborting LTE registration.
Aspect 13: The method of Aspect 5, wherein reconnecting to the first RAT service includes, if no available NR neighbor is found: triggering a background public land mobile network search; and connecting to the NR service if an NR cell is found.
Aspect 14: The method of Aspect 5, wherein reconnecting to the first RAT service includes, if an available NR neighbor is found, prioritizing NR frequencies, prioritizing scheduling of NR measurements, opening an autonomous gap for NR measurements, triggering local fast redirection to the first RAT service, or any combination thereof.
Aspect 15: The method of Aspect 5, wherein reconnecting to the first RAT service includes triggering an acquisition database scan starting from NR, aborting LTE registration, or any combination thereof.
Aspect 16: The method of any of Aspects 1-4, wherein the first RAT service is a New Radio (NR) service in frequency range 1 (FR1) and the second RAT service is an NR service in FR2.
Aspect 17: The method of any of Aspects 1-4, wherein the first RAT service is a New Radio (NR) service in frequency range 2 (FR2) and the second RAT service is an NR service in FR1.
Aspect 18: An apparatus for wireless communication at a device, comprising a processor; memory coupled with the processor; and instructions stored in the memory and executable by the processor to cause the apparatus to perform the method of one or more of Aspects 1-17.
Aspect 19: A device for wireless communication, comprising a memory and one or more processors coupled to the memory, the one or more processors configured to perform the method of one or more of Aspects 1-17.
Aspect 20: An apparatus for wireless communication, comprising at least one means for performing the method of one or more of Aspects 1-17.
Aspect 21: A non-transitory computer-readable medium storing code for wireless communication, the code comprising instructions executable by a processor to perform the method of one or more of Aspects 1-17.
Aspect 22: A non-transitory computer-readable medium storing a set of instructions for wireless communication, the set of instructions comprising one or more instructions that, when executed by one or more processors of a device, cause the device to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
disconnecting from a first radio access technology (RAT) service, independent of signaling from the first RAT service, after sensing that the UE has entered a coverage hole;
using a connection to a second RAT service while in the coverage hole in association with disconnecting from the first RAT service;
disconnecting from the second RAT service, independent of signaling from the second RAT service, after sensing that the UE has exited the coverage hole and before expiration of a radio link failure (RLF) timer for the second RAT service; and
reconnecting to the first RAT service before expiration of an RLF timer for the first RAT service.

2. The method of claim 1, wherein sensing that the UE has entered the coverage hole includes sensing that the UE has entered the coverage hole based at least in part on a determination that one or more sensor values have satisfied a coverage hole threshold, and wherein sensing that the UE has exited the coverage hole includes sensing that the UE has exited the coverage hole based at least in part on a determination that one or more sensor values no longer satisfy the coverage hole threshold.

3. The method of claim 2, wherein the one or more sensor values include one or more of a signal strength value, an accelerometer value, a proximity sensor value, a barometric pressure value, a light sensor value, a positioning value, a microphone input value, or any combination thereof.

4. The method of claim 1, wherein sensing that the UE has entered the coverage hole includes sensing that the UE has entered an elevator, a tunnel, a below-ground floor, underground parking, or a subway, and wherein sensing that the UE has exited the coverage hole includes sensing that the UE has exited the elevator, the tunnel, the below-ground floor, the underground parking, or the subway.

5. The method of claim 1, wherein the first RAT service is a New Radio (NR) service and the second RAT service is a Long Term Evolution (LTE) service.

6. The method of claim 5, wherein the first RAT service is a standalone NR service.

7. The method of claim 5, wherein the first RAT service is a dual connectivity NR service.

8. The method of claim 5, wherein reconnecting to the first RAT service includes, if an available NR neighbor is found, prioritizing NR frequencies, prioritizing scheduling of NR measurements, opening an autonomous gap for NR measurements, triggering local fast redirection to the first RAT service, or any combination thereof.

9. The method of claim 5, wherein reconnecting to the first RAT service includes triggering an acquisition database scan starting from NR, aborting LTE registration, or any combination thereof.

10. The method of claim 5, wherein reconnecting to the first RAT service includes, if no available NR neighbor is found:
triggering a background public land mobile network search; and
connecting to the NR service if an NR cell is found.

11. The method of claim 1, wherein the first RAT service is a New Radio (NR) service in frequency range 1 (FR1) and the second RAT service is an NR service in FR2, or the first RAT service is a New Radio (NR) service in frequency range 2 (FR2) and the second RAT service is an NR service in FR1.

12. A user equipment (UE) for wireless communication, comprising:
a memory; and
one or more processors, coupled to the memory, configured to:
disconnect from a first radio access technology (RAT) service, independent of signaling from the first RAT service, after sensing that the UE has entered a coverage hole;
use a connection to a second RAT service while in the coverage hole in association with disconnecting from the first RAT service;
disconnect from the second RAT service, independent of signaling from the second RAT service, after sensing that the UE has exited the coverage hole and before expiration of a radio link failure (RLF) timer for the second RAT service; and
reconnect to the first RAT service before expiration of an RLF timer for the first RAT service.

13. The UE of claim 12, wherein the one or more processors, to sense that the UE has entered the coverage hole, are configured to sense that the UE has entered the coverage hole based at least in part on a determination that one or more sensor values have satisfied a coverage hole threshold, and wherein the one or more processors, to sense that the UE has exited the coverage hole, are configured to sense that the UE has exited the coverage hole based at least in part on a determination that one or more sensor values no longer satisfy the coverage hole threshold.

14. The UE of claim 13, wherein the one or more sensor values include one or more of a signal strength value, an accelerometer value, a proximity sensor value, a barometric pressure value, a light sensor value, a positioning value, a microphone input value, or any combination thereof.

15. The UE of claim 12, wherein the one or more processors, to sense that the UE has entered the coverage hole, are configured to sense that the UE has entered an elevator, a tunnel, a below-ground floor, underground parking, or a subway, and wherein the one or more processors, to sense that the UE has exited the coverage hole, are configured to sense that the UE has exited the elevator, the tunnel, the below-ground floor, the underground parking, or the subway.

16. The UE of claim 12, wherein the first RAT service is a New Radio (NR) service and the second RAT service is a Long Term Evolution (LTE) service.

17. The UE of claim 16, wherein the first RAT service is a standalone NR service or a dual connectivity NR service.

18. The UE of claim 16, wherein the one or more processors, to reconnect to the first RAT service, are configured to:
if an available NR neighbor is found, prioritize NR frequencies, prioritize scheduling of NR measurements, open an autonomous gap for NR measurements, trigger local fast redirection to the first RAT service, or any combination thereof, or
if no available NR neighbor is found:
trigger a background public land mobile network search; and
connect to the NR service if an NR cell is found.

19. The UE of claim 16, wherein the one or more processors, to reconnect to the first RAT service, are configured to trigger an acquisition database scan starting from NR, abort LTE registration, or any combination thereof.

20. The UE of claim 12, wherein the first RAT service is a New Radio (NR) service in frequency range 1 (FR1) and the second RAT service is an NR service in FR2, or the first RAT service is a New Radio (NR) service in frequency range 2 (FR2) and the second RAT service is an NR service in FR1.
